(19) United States
(12) Patent Application Publication
(10) Pub. No.: US 2012/0147020 A1
(43) Pub. Date: Jun. 14, 2012

(54) METHOD AND APPARATUS FOR PROVIDING INDICATION OF A STATIC FRAME

(75) Inventors: Syed A. Hussain, Scarborough (CA); David I.J. Glen, Toronto (CA); Collis Quinn Carter, Richmond Hill (CA); Andjelija Masnikosa, Richmond Hill (CA)

(73) Assignee: ATI TECHNOLOGIES ULC, Markham (CA)

(21) Appl. No.: 12/966,359

(22) Filed: Dec. 13, 2010

(51) Int. Cl. G06T 1/00

(52) U.S. Cl. 345/522

(57) ABSTRACT

A method and apparatus provides for providing an indication of a static frame. In one example, the method and apparatus notifies the arrival of a static frame by changing a vertical blanking interval for the static frame. For example, the method and apparatus may determine that a display frame is a static frame if no graphic processing activity and/or lack of update to the frame buffer have been detected for a period of time. In response to a display frame being a static frame, the method and apparatus may change the vertical blanking interval that is immediately before the static frame by increasing the number of blanking scan lines in the vertical blanking interval. The changed vertical blanking interval may be transmitted with the static frame as an indicator of the arrival of a static frame, so that the apparatus may enter a self-refresh mode to repeatedly display the static frame.

### CROSS-REFERENCE TO RELATED APPLICATION

This application is related to co-pending application having application Ser. No. 12/956,740, filed on Nov. 30, 2010, having inventors Andjelija Masnikosa et al., titled “METHOD AND APPARATUS FOR PROVIDING STATIC FRAME”, and owned by instant assignee.

### BACKGROUND OF THE DISCLOSURE

The disclosure relates generally to a method and apparatus for providing an indication of a static frame.

Systems for processing and displaying graphics usually include a graphic sub-system such as a graphic processing unit (GPU) for providing display data and a display device for presenting display content. The display device usually includes or couples to a controller such as a timing controller (TCON) that acts as an interface and controller for a display panel of the display device. For example, the TCON receives display data from the GPU with control instructions, and controls writing of pixels and directs operations of the display panel. In addition to display data in display frames, other data, such as but not limited to test signals, time codes, closed captions, copy-right indicators, and content ratings, may be transmitted in vertical blanking intervals (VBI) from the GPU to the TCON. The VBI, also known as VBLANK, is the time difference between the last line of one display frame and the first line of the next display frame. The incoming data stream in the VBI is consisted of a number of blanking scan lines that are not displayed on the screen. The length or the number of the blanking scan lines of the VBI may vary among different graphic processing and display systems.

In order to reduce power consumption of the system, when no graphic processing activity and/or lack of update to the frame buffer have been detected for a period of time, both the GPU and the TCON may enter a self-refresh mode that includes powering down one or more components, capturing the current display frame from the GPU as a static frame, and repeatedly outputting the captured static frame to the display panel for display. To enter the self-refresh mode, the static frame is captured from a frame buffer of the graphic sub-system to the TCON and is stored in a static frame buffer of the TCON for display. The graphic sub-system needs to notify the TCON that the captured static frame is arrived and can be stored in the static frame buffer before switching to the self-refresh mode.

In responding to these situations, some known systems introduce new secondary packets in addition to the display frames for notification of the arrival of a static frame. The secondary packet contains information of whether the associated display frame is a static frame or a dynamic frame. The packet-based approach, however, requires a change to the Video Electronics Standards Association (VESA) DisplayPort standard in order to embed extra packets into the data channel (also known as the main link), which is undesirable for the current graphic processing and display systems.

Other proposed solutions utilize the sideband channel (also known as auxiliary (AUX) channel in the DisplayPort standard) to transmitting control/status signals for notification of the arrival of a static frame. For example, the I²C (inter-integrated circuit) bus is used by some known systems (for example, VGA, LVDS, DVI and HDMI) for transmitting the control/status signals. However, it's known that the sideband channels such as the I²C bus suffer has various limitations such as the low speed. In addition, as the control/status signals and the display frames are transmitted through different channels (i.e., the sideband channel and the data channel, respectively), the control/status signals need to be synchronized with the display frames in order to accurately indicate the arrival of the static frame. As such, additional timing signals and synchronization operations may be necessary in these systems.

It is also known to change the length of VBIs in a graphic processing and display system to achieve a dynamic-refreshing feature. In that system, the refresh rate of the display frame displayed on the screen may be dynamically changed by changing the length of the VBIs between each display frame. Nevertheless, the changed VBIs have not been applied for notification of the arrival of a static frame from a display data transmitter, e.g., a processor such as, for example, a graphic processing unit (GPU), to a display data receiver, e.g., a timing controller (TCON).

Accordingly, there exists a need for an improved method and apparatus for providing the indication of a static frame.

### BRIEF DESCRIPTION OF THE DRAWINGS

The embodiments will be more readily understood in view of the following description when accompanied by the below figures and wherein like reference numerals represent like elements, wherein:

FIG. 1 is a block diagram illustrating one example of an apparatus for providing an indication of a static frame;

FIG. 2 is a flowchart illustrating one example of a method for providing an indication of a static frame;

FIG. 3 an illustration of one example of display frames with vertical blanking intervals transmitted from a display data transmitter to a display data receiver;

FIG. 4 is a block diagram illustrating one example of a display data transmitter of the apparatus for providing an indication of a static frame shown in FIG. 1 in accordance with one embodiment set forth in the disclosure;

FIG. 5 is a flowchart illustrating one example of a method for providing an indication of a static frame;

FIG. 6 is a block diagram illustrating one example of a display data receiver of the apparatus for providing an indication of a static frame shown in FIG. 1 in accordance with one embodiment set forth in the disclosure;

FIG. 7 an illustration of one example of display frames with vertical blanking intervals transmitted from a display data receiver to a display panel; and

FIG. 8 is a flowchart illustrating one example of a method for providing an indication of a static frame.

### DETAILED DESCRIPTION OF THE PREFERRED EMBODIMENTS

Briefly, in one example, a method and apparatus notifies the arrival of a static frame by changing a vertical blanking interval for the static frame. For example, the method and apparatus may determine that a display frame is a static frame if no graphic processing activity and/or lack of update to the frame buffer have been detected for a period of time. In response to a display frame being a static frame, the method and apparatus may change the vertical blanking interval that is immediately before the static frame by increasing the number of blanking scan lines in the vertical blanking interval. The changed vertical blanking interval may be transmitted with the static frame as an indicator of the arrival of the static frame, so that the apparatus may enter a self-refresh mode to repeatedly display the static frame.

Among other advantages, the method and apparatus provides a simple way to notify the arrival of a static frame, thereby reducing the overall complexity of implementing the self-refreshing feature in graphic processing and display systems. Compared with known solutions, the method and apparatus does not need to change the current DisplayPort standard to add new secondary packets for each display frame, or to transmit additional unsynchronized control/status signals through the sideband channel in order to notify the arrival of a static frame. In addition, the method and apparatus allows for a faster entry/exit time than known solutions, thereby providing a more seamless transition between the normal and self-refresh modes. Other advantages will be recognized by those of ordinary skill in the art.

In one example, the method and apparatus further disables the data channel used to transmit the static frame with the changed vertical blanking interval after transmitting the static frame with the changed vertical blanking interval. The data channel may be disabled by disabling one or more interfaces used for communicating the display frame and the vertical blanking interval.

In another example, the method apparatus also determines that a display frame is a dynamic frame. In response to a display frame being a dynamic frame, the method and apparatus enables the data channel if it has been disabled to switch the apparatus to a normal mode. The method and apparatus then transmits the dynamic frame with an unchanged vertical blanking interval for the dynamic frame.

In one embodiment set forth in the disclosure, the method and apparatus receives a display frame with a vertical blanking interval for the display frame. The vertical blanking interval for the display frame may be received immediately before the display frame. The method and apparatus then determines whether the received vertical blanking interval is an unchanged vertical blanking interval or a changed vertical blanking interval in order to determine whether the received display frame is a dynamic frame or a static frame. For example, the method and apparatus may identify the different vertical blanking intervals by the number of blanking scan lines in the vertical blanking interval. In one example, the changed vertical blanking interval has a larger number of blanking scan lines than the unchanged vertical blanking interval.

In one example, if the received vertical blanking interval is determined to be a changed vertical blanking interval, then the received display frame is a static frame, and the apparatus enters the self-refresh mode. The method and apparatus stores the static frame and outputs the stored static frame repeatedly for display.

In another example, if the received vertical blanking interval is determined to be an unchanged vertical blanking interval, then the received display frame is a dynamic frame. The method and apparatus outputs the received dynamic frame for display directly.

Among other advantages, the method and apparatus provides a simple way to notify the arrival of a static frame, thereby reducing the overall complexity of implementing the self-refreshing feature in graphic processing and display systems. Compared with known solutions, the method and apparatus does not need to change the current DisplayPort standard to add new secondary packets for each display frame, or to transmit additional unsynchronized control/status signals through the sideband channel in order to notify the arrival of a static frame. In addition, as the vertical blanking intervals usually occur at an accurately known frequency, the timing of the notification may be also synchronized to the display frame timing without extra timing signals and synchronization operations. Accordingly, compared with the conventional techniques, the proposed techniques can reduce the complexity of the hardware design and the communication protocol or interface standard of the graphic processing and display systems with the self-refreshing feature. Moreover, the method and apparatus allows for a faster entry/exit time than known solutions, thereby providing a more seamless transition between the normal and self-refresh modes. Other advantages will be recognized by those of ordinary skill in the art.

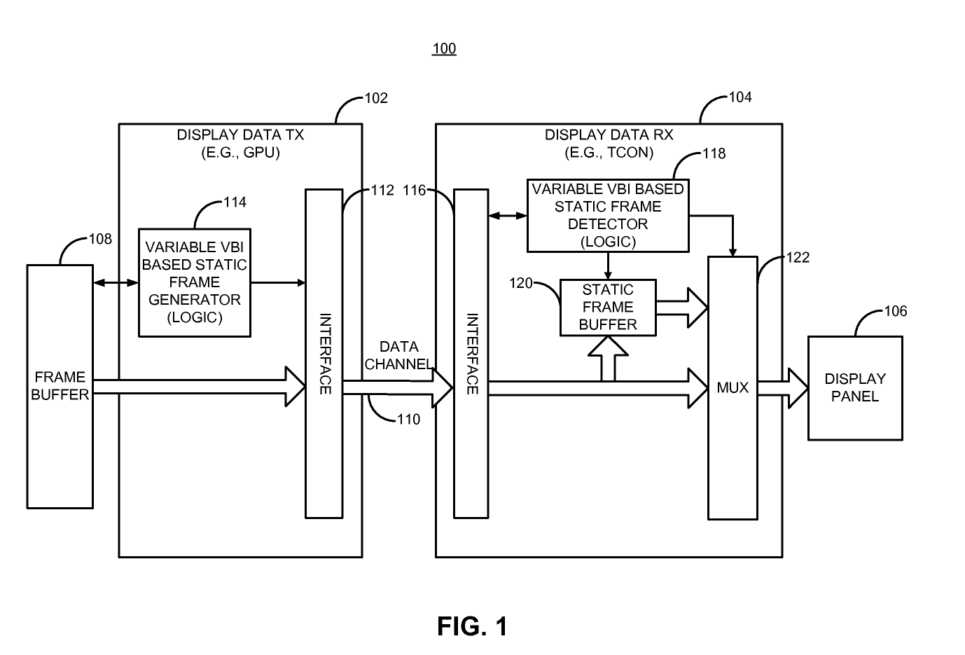

FIG. 1 illustrates one example of an apparatus 100 for providing an indication of a static frame. The apparatus 100 may be any suitable device, for example, a laptop computer, desktop computer, media center, handheld device (e.g., mobile or smart phone, tablet, etc.), Blu-ray™ player, gaming console, set top box, printer, or any other suitable device. In this example, the apparatus 100 will be described as a computer system such as a laptop computer. The apparatus 100 may include a display data transmitter 102, a display data receiver 104, and a display panel 106. In this example, the apparatus 100 may also include a frame buffer 108 that is operatively coupled to the display data transmitter 102. In other examples, the frame buffer 108 may be part of the display data transmitter 102. The display data receiver 104 is operatively coupled to the display data transmitter 102 through a plurality of communication links such as a data channel 110 (also known as the main link) for transmitting at least display data. The display data receiver 104, in this example, is also operatively coupled to the display panel 106 to output display frames to the display panel 106 for display. It is understood that any other suitable component may also be included in the apparatus 100, such as but not limited to a bi-directional sideband channel (also known as the AUX channel in the DisplayPort standard) between the display data transmitter 102 and the display data receiver 104 for transmitting control and/or status signals.

The display data transmitter 102 may be, for example, a graphic processor (e.g., GPU), a general processor (e.g., APU, accelerated processing unit; GPGPU, general-purpose computing on GPU), or any other suitable processor. The display data transmitter 102 may also be a stand-alone integrated circuit that is operatively coupled to one or more processors or coupled to any suitable display system. In this example, the display data transmitter 102 includes an interface 112 for communicating with the display data receiver 104. The interface 112 may transmit display data in a display frame (e.g., a dynamic frame or a static frame) and other data such as but not limited to test signals, time codes, closed captions, copy-right indicators, content ratings, or any other suitable data in a vertical blanking interval (VBI) through the data channel 110. The interface 112 may be, for example, a display connector, such as but not limited to a digital display connector, for example, DisplayPort, HDMI, OpenLDI, to name a few, a wireless connector, or any other suitable connector.

The display data transmitter 102 also includes logic 114 operatively coupled to the interface 112 and the frame buffer 108. The “logic” referred to herein may be any suitable hardware, executing firmware, executing software module, or any suitable combination thereof that can perform the desired function, such as programmed processors, discrete logic, for example, state machine, to name a few. In this example, the logic 114 may be any suitable circuit that can achieve the desired function, such as a digital circuit, an analog circuit, a mixed analog-digital circuit, or any other suitable circuit. The logic 114 is operative to determine whether a display frame in the frame buffer 108 is a static frame or a dynamic frame. If the logic 114 determines that the next display frame to be transmitted to the display data receiver 104 is a static frame, it is operative to, in response to a display frame being a static frame, change a number of blanking scan lines in a VBI for the static frame to provide a changed VBI for the static frame. In this example, the logic 114 is also operative to control the interface 112 to transmit the static frame with the changed VBI for the static frame to the display data receiver 104.

The display data receiver 104 of the apparatus 100 may be, for example, any suitable controller (e.g., timing controller, TCON) for receiving display data and any other data from the display data transmitter 102 and for controlling writing of pixels and directing operations of the display panel 106. The display data receiver 104 may also be a video capture device, a hub, a repeater, a wireless radio device, a protocol translator, or any suitable data receiver. In this example, the display data receiver 104 includes an interface 116 for communicating with the display data receiver 104. The interface 116 is operative to receive display data and other data as described previously through the data channel 110. The interface 116 may be, for example, a display connector, such as but not limited to a digital display connector, for example, DisplayPort, HDMI, OpenLDI, to name a few, a wireless connector, or any other suitable connector.

The display data receiver 104 may include a static frame buffer 120 and a multiplexer (MUX) 122. The static frame buffer 120 is operatively coupled to the interface 116 and the MUX 122. In this example, the static frame buffer 120 is operative to store the static frame in the self-refresh mode. The MUX 122 is operative to switch between directly outputting dynamic frames received by the interface 116 in the normal mode and outputting the static frame stored in the static frame buffer 120 in the self-refresh mode.

The display data receiver 104 also includes logic 118 operatively coupled to the interface 116, the static frame buffer 120, and the MUX 122. The “logic” referred to herein may be any suitable hardware, executing firmware, executing software module, or any suitable combination thereof that can perform the desired function, such as programmed processors, discrete logic, for example, state machine, to name a few. In this example, the logic 118 may be any suitable circuit that can achieve the desired function, such as a digital circuit, an analog circuit, a mixed analog-digital circuit, or any other suitable circuit.

The logic 118 is operative to continuously monitor all the VBIs received by the interface 116 to detect a changed VBI based on the number of blanking scan lines in the VBI. In the normal mode, the display data transmitter 102 continuously transmits dynamic frames with unchanged VBIs to the interface 116 of the display data receiver 104. As all the VBIs in the normal mode are unchanged VBI, which indicate that all the received display frames are dynamic frames, the logic 118 is operative to prevent the static frame buffer 120 from storing the received dynamic frames, and control the MUX 122 to output the dynamic frames from the interface 116 directly to the display panel 106. In the self-refresh mode, the display data transmitter 102 transmits a static frame with a changed VBI to the display data receiver 104. In response to detecting the changed VBI received by the interface 116, the logic 118 is operative to control the static frame buffer 120 to store the received static frame. The logic 118 in the self-refresh mode is further operative to control the MUX 122 to output the stored static frame from the static frame buffer 120, as opposed to output the dynamic frame from the interface 116 directly in the normal mode. In the self-refresh mode, the static frame stored in the static frame buffer 120 is outputted to the display panel 106 repeatedly, and thus, the data channel 110 can be disabled to reduce power consumption.

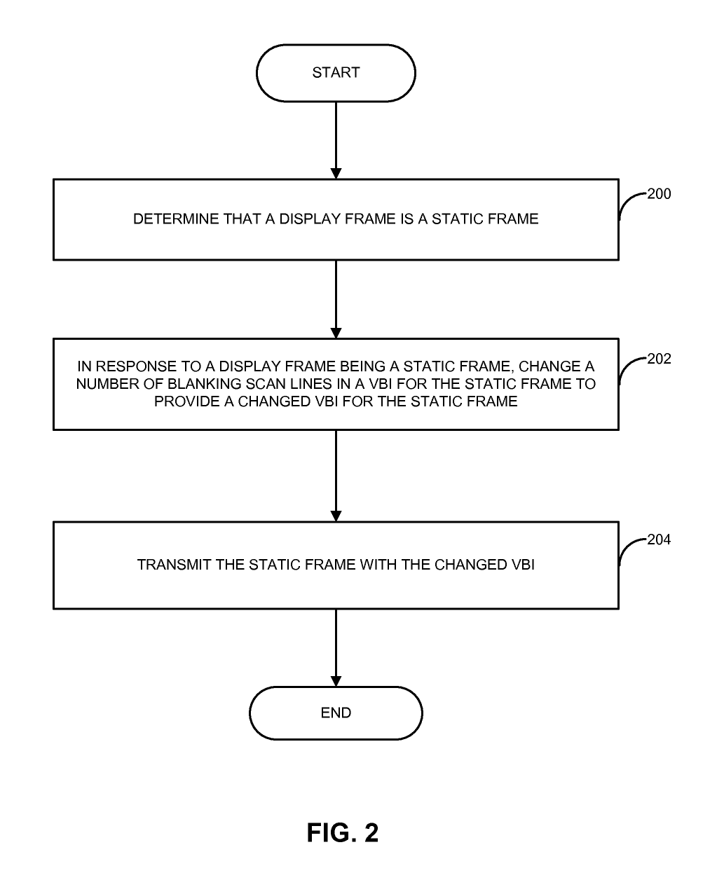

FIG. 2 illustrates one example of a method for providing an indication of a static frame. It will be described with reference to FIG. 1. However, any suitable logic or structure may be employed. In operation, the logic 114 of the display data transmitter 102, at block 200, determines that a display frame is a static frame. For example, when no graphic processing activity and/or lack of update to the frame buffer 108 have been detected for a period of time by the logic 114, the logic 114 determines that the apparatus 100 can enter the self-refresh mode to reduce power consumption and that the current display frame in the frame buffer 108 is a static frame to be copied to the static frame buffer 120 in the display data receiver 104.

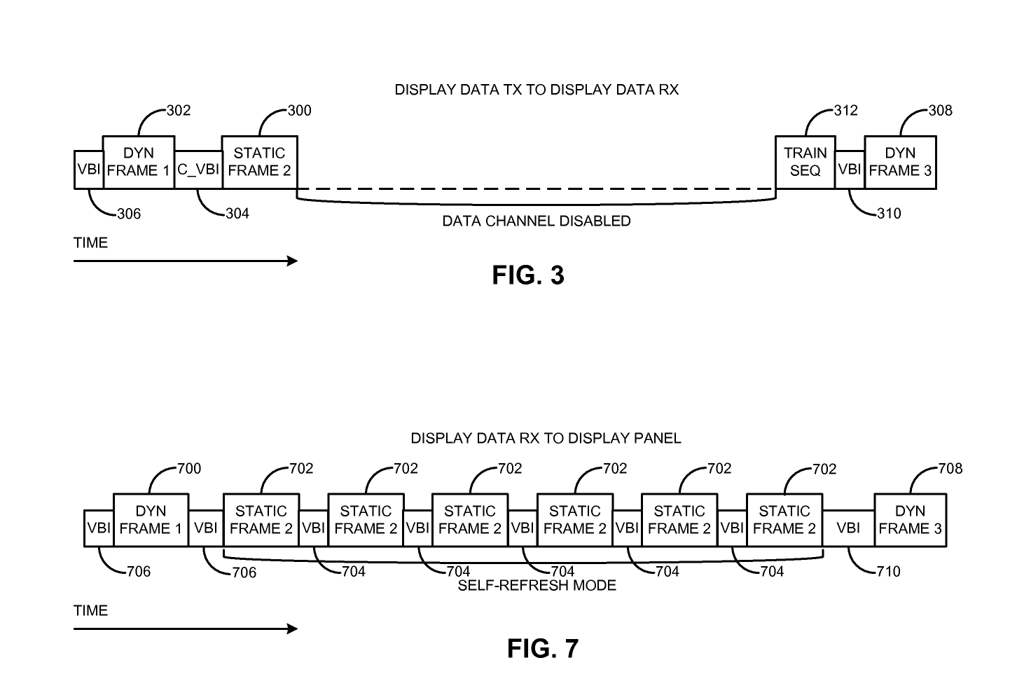

At block 202, in order to distinguish the static frame (e.g., static frame 300 in FIG. 3) from the dynamic frame (e. g., dynamic frame 302 in FIG .3) and to notify the display data receiver 104 that the next transmitted display frame is a static frame, the logic 114 changes the number of blanking scan lines in a VBI for the static frame 300 to provide a changed VBI 304 for the static frame 300. It is understood that each display frame has two adjacent VBIs, i.e., a VBI that is immediately before the display frame and a VBI that is immediately after the display frame. It is preferred, in this example, to change a VBI that is immediately before the static frame 300 to provide the changed VBI 304 for the static frame 300 as shown in FIG. 3. In other examples, a changed VBI may be provided immediately after the static frame if desired.

The standard number of blanking scan lines in a VBI depends on, for example, the number of scan lines in the display frame and the specific type of the apparatus 100. In one example, the apparatus 100 may be a laptop computer that is operating on a 1280 by 1024 resolution. Each display frame for this laptop computer has 1024 scan lines, and the standard VBI for the display frame may have 30 blanking scan lines. In another example, the apparatus 100 may be a high definition home theater system that is operating on a 1920 by 1080 resolution. Each display frame for this system has 1080 scan lines, and the standard VBI for the display frame may have 45 blanking scan lines.

Nevertheless, the number of blanking scan lines in the VBI for the static frame is changed from the standard number as explained above to a changed number to indicate that the display frame is a static frame. It is preferred, in this example, to increase the number of blanking scan lines in the changed VBI 304 to distinguish it from the unchanged VBI 306 (i.e., standard VBI) as shown in FIG. 3. In other examples, a changed VBI may have a smaller number of blanking scan lines compared with an unchanged/standard VBI if desired. It is also understood that the number change of the blanking scan lines is arbitrary, as long as it is enough to distinguish the changed VBI from the unchanged/standard VBI by the display data receiver 104. In one example, if an unchanged/standard VBI has 30 blanking scan lines, a changed VBI in the same apparatus 100 may have 33 or more blanking scan lines, which is 10% more than the unchanged/standard VBI.

In a preferred embodiment, a reference value or a reference range of the number of blanking scan lines may be determined by pre-negotiating between the logic 114 of the display data transmitter 102 and the logic 118 of the display data receiver 104. The number of blanking scan lines of a changed VBI is increased to the reference value or within the reference range to distinguish from the unchanged/standard VBI; and any received VBI that has the same number of blanking scan lines larger as the reference value or has the number of blanking scan lines within the reference range is determined as a changed VBI. Such reference value or reference range is stored in both the logic 114 of the display data transmitter 102 and the logic 118 of the display data receiver 104 after the pre-negotiation.

It is understood that the changed VBI is not limited to indicate only the arrival of a static frame. For example, a particular range of the number of blanking scan lines in a changed VBI may be defined to indicate a static frame, while another range of the number of blanking scan lines in a changed VBI may indicate another feature in addition to the arrival of a static frame. Such feature may be, for example, a dynamic refresh rate change or any other suitable feature. For example, for a system in which unchanged/standard VBI has 30 blanking scan lines, a changed VBI having 33 blanking scan lines may indicate that the associated display frame is a static frame, and another changed VBI having more than 35 blanking scan lines in the same system may indicate that the associated display frame is a static frame and the static frame is to be displayed in a dynamic refresh rate. It is also understood that the change of VBI is not limited to the change of the number of blanking scan lines. Any suitable change of one or more characteristics of the VBI that can distinguish it from a standard VBI and can be recognized by the display data receiver 104 may be applied to indicate that an adjacent display frame of the VBI is a static frame.

Proceeding to block 204, the logic 114 controls the interface 112 to transmit the static frame 300 with the changed VBI 304 for the static frame 300. Also referring to FIG. 3, in this example, after controlling the interface 112 to transmit the dynamic frame 302, the logic 114 controls the interface 112 to transmit the changed VBI 304 provided at block 202 and the static frame 300 immediately after the changed VBI 304 to the display data receiver 104 through the data channel 110. As such, in this example, it may not be necessary to further notify the display data receiver 104 that the apparatus 100 is now entering the self-refresh mode by transmitting extra control/status signals through a sideband (AUX) channel. The changed VBI 304 itself serves as an indication of the arrival of the static frame 300 and the switch to the self-refresh mode.

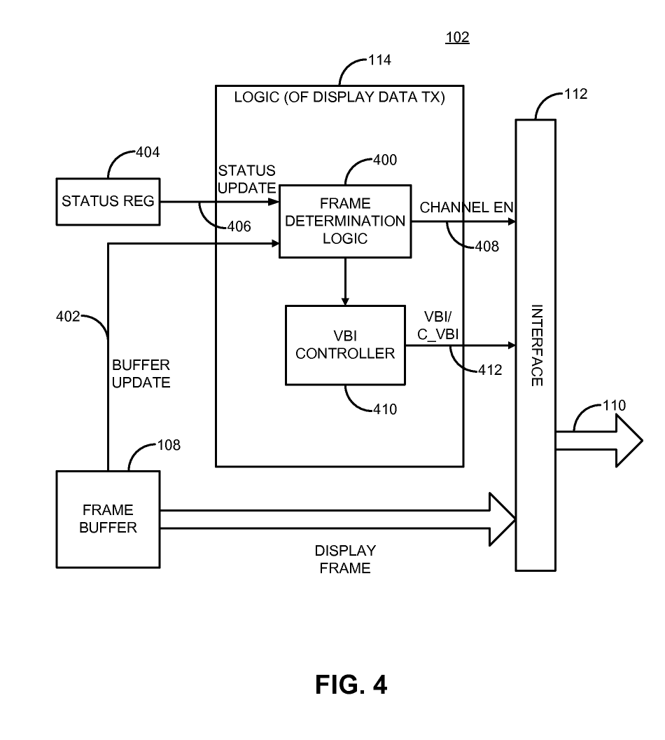

FIG. 4 is a block diagram illustrating one example of the display data transmitter 102 of the apparatus 100 for providing an indication of a static frame. In this example, the logic 114 of the display data transmitter 102 includes frame determination logic 400 operatively coupled to the frame buffer 108 and the interface 112. The frame determination logic 400 is operative to determine whether a display frame is a static frame or a dynamic frame. In other words, the frame determination logic 400 is operative to control switching of the apparatus 100 between the self-refresh mode and the normal mode. As explained previously, the decision may be made based on whether a graphic processing activity has been detected for a period of time. The graphic processing activity may be indicated by a buffer update signal 402 (e.g., buffer write access) from the frame buffer 108 in response to any content change of the display frame stored in the frame buffer 108. If no buffer update signal 402 has been received from the frame buffer 108 over a threshold time period, the frame determination logic 400 may determine that the current display frame in the frame buffer 108 is a static frame, and the apparatus 100 may switch to the self-refresh mode. It is also understood that, in other examples, the display data transmitter 102 may further include or couple to a status register 404 that also indicates the graphic processing activity. For example, the status register 404 may record the current position of the mouse cursor on the screen. In this example, the display data of the mouse cursor (e.g., coordinates of the cursor position) is not stored as part of the display frame in the frame buffer 108, but instead, it is separately stored in the status register 404 and is overlaid onto the display frame in the frame buffer 108 for display. In this situation, the status update signal 406 such as the position change of the mouse cursor is also provided to the frame determination logic 400 to decide whether a graphic processing activity, e.g., the mouse cursor movement caused by user activities, occurs in the threshold time period. Other detection mechanisms are possible, such as but not limited to detection of difference between data read from the frame buffer 108 compared with the previous frame, an indication of write activity, or a system idle indication.

As no display frame needs to be transmitted from the display data transmitter 102 to the display data receiver 104 in the self-refresh mode, the frame determination logic 400 is also operative to disable the interface 112 by a channel enabling/disabling signal 408. By disabling the interface 112 and the activities on the data channel 110, the power consumption of the display data transmitter 102 is reduced in the self-refresh mode.

The logic 114 may further include a VBI controller 410 operatively coupled to the frame determination logic 400 and the interface 112. The VBI controller 410 is operative to provide variable VBIs 412 for each display frame based on whether the display frame is a dynamic frame or a static frame determined by the frame determination logic 400. Also referring to FIG. 3, in a preferred example, the VBI controller 410 is operative to provide a changed VBI 304 that has a larger number of blanking scan lines than the unchanged VBI 306. The changed VBI 304 is provided for the static frame 300 while the unchanged VBI 306 is provided for the dynamic frame 302. The VBI controller 410 is further operative to control the interface 112 to transmit the display frame with the VBI 412 to the display data receiver 104 through the data channel 110. Also referring to FIG. 3, in a preferred example, the VBI controller 410 is operative to control the interface 112 to transmit the changed VBI 304 immediately before its associated static frame 300.

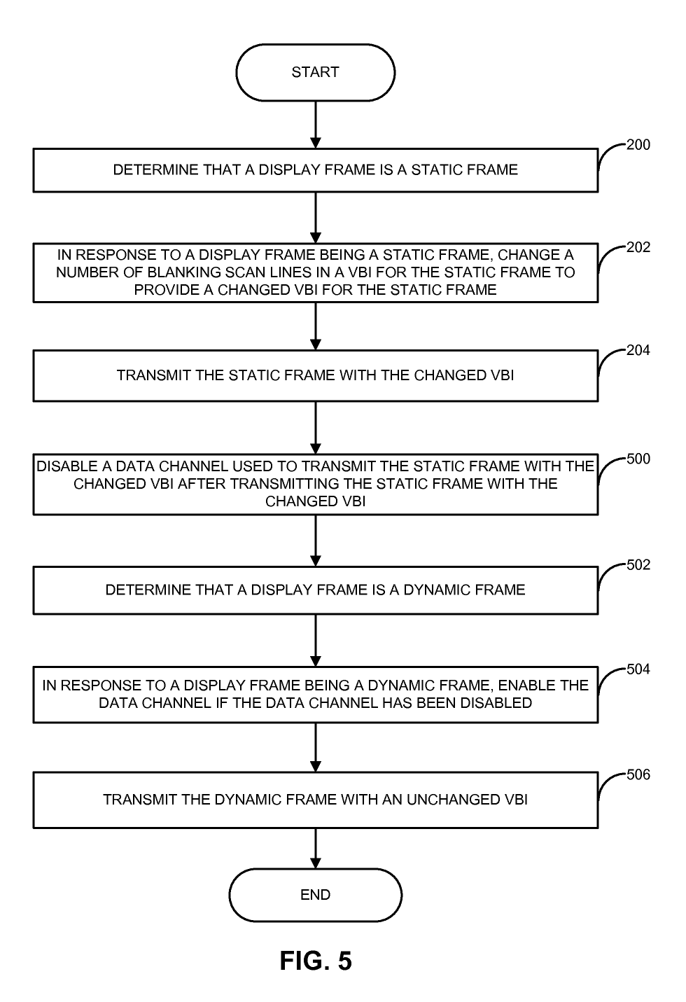

FIG. 5 illustrates an example of a method for providing an indication of a static frame. It will be described with reference to FIGS. 1 and 4. However, any suitable logic or structure may be employed. In operation, at block 200, the frame determination logic 400 of the logic 114 determines that a display frame is a static frame 300 (also referring to FIG. 3). At block 202, the VBI controller 410 of the logic 114, in response to a display frame being a static frame, changes the number of blanking scan lines in a VBI for the static frame 300 to provide a changed VBI 304 for the static frame 300. At block 204, the VBI controller 410 controls the interface 112 to transmit the static frame 300 with the changed VBI 304 for the static frame 300 to the display data receiver 104. Proceeding to block 500, after transmitting the static frame 300 with the changed VBI 304, the frame determination logic 400 disables the data channel 110 by disabling the interface 112.

At block 502, the frame determination logic 400 may determine that a display frame is a dynamic frame 302, 308 in response to detecting a graphic processing activity. At block 504, if the dynamic frame 308 is the first dynamic frame determined after the self-refresh mode, the frame determination logic 400 is operative to enable the data channel 110 that has been disabled in the self-refresh mode, so that the dynamic frame 308 may be transmitted to the display data receiver 104. Otherwise, if the dynamic frame 302 is determined before the apparatus 100 enters the self-refresh mode, block 504 may be skipped as the data channel 110 is enabled. Further to block 506, the VBI controller 410, in response to determining the dynamic frames 302, 308, controls the interface 112 to transmit the dynamic frames 302, 308 with the unchanged VBIs 306, 310 for the dynamic frames 302, 308 to the display data receiver 104 through the data channel 110. In one example as shown in FIG. 3, if the dynamic frame 308 is the first dynamic frame after the self-refresh mode, the logic 114 may transmit a training sequence 312 before the unchanged VBI 310 and the dynamic frame 308. The training sequence 312, as known in the art, may carry information that is necessary for the display data receiver 104 to initial its configurations for receiving dynamic frame after switching back to the normal mode. In the self-refresh mode, the interface 116 of the display data receiver 104 is switched to a power saving mode with the capability to monitor certain activities in the data channel 110 including the training sequence 321. Thus, training sequence 312 may also trigger the interface 116 to switch to the normal mode so that it can receive the incoming dynamic frame 308 from the display data transmitter 102. Nevertheless, the VBI controller 410 provides the unchanged VBIs 306, 310 as indicators of dynamic frames 302, 308 in the normal mode.

Although the processing blocks illustrated in FIG. 5 are illustrated in a particular order, those having ordinary skill in the art will appreciate that the processing can be performed in different orders. For example, blocks 200-204 may be performed after blocks 502-506. As shown in FIG. 3, the static frame 300 may be determined after the dynamic frame 302.

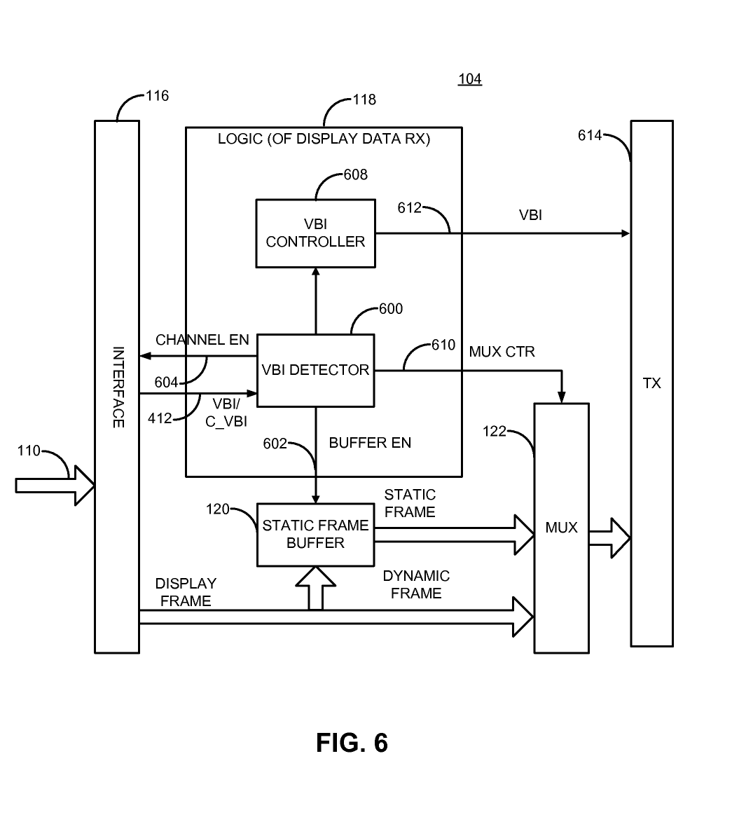

FIG. 6 is a block diagram illustrating one example of the display data receiver 104 of the apparatus 100 for providing an indication of a static frame. The interface 116 of the display data receiver 104 is operative to receive display frames with VBIs 412 from the display data transmitter 102 and separate the VBIs 412 from the display data for determination. In this example, the display data receiver 104 includes a VBI detector 600 operatively coupled to the interface 116, the static frame buffer 120, and the MUX 122. The VBI detector 600 is operative to detect the changed VBI 304 from all the VBIs 412 received by the interface 116.

As explained previously, the detection of the changed VBI 304 may be performed, for example, by counting the number of blanking scan lines in each received VBI 412. A reference value or a reference range of the number of blanking scan lines may be stored in the VBI detector 600 to detect the changed VBI 304. Any received VBI that has the same number of blanking scan lines larger as the reference value or has the number of blanking scan lines within the reference range is determined as a changed VBI 304. For example, the reference value or the reference range is determined by pre-negotiating between the logic 114 of the display data transmitter 102 and the logic 118 of the display data receiver 104.

The VBI detector 600 is also operative to control the operation of the static frame buffer 120 by a buffer enabling signal 602. In the normal mode, the VBI detector 600 detects that the received VBIs 412 are unchanged VBIs and thus, the received display frames are dynamic frames. The VBI detector 600 disables the static frame buffer 120, so that all the dynamic frames in the normal mode are not stored in the static frame buffer 120. Also referring to FIG. 3, when the VBI detector 600 detects a changed VBI 304, it transmits the buffer enabling signal 602 to enable the static frame buffer 120, so that the static frame 300 immediately after the changed VBI 304 is stored in the static frame buffer 120, and the apparatus 100 switches to the self-refresh mode. In the self-refresh mode, the VBI detector 600 is also operative to transmit a channel enabling/disabling signal 604 to the interface 116 to switch the interface 116 into the power saving mode. In the power saving mode, the interface 116 is operative to detect certain activity on the data channel 110 including the training sequence 312 and quickly come back up to the normal mode in which the interface 116 can lock to the incoming training sequence 312 and dynamic frame 308.

The VBI detector 600 is further operative to control the MUX 122 to switch between outputting the dynamic frame in the normal mode and outputting the stored static frame in the self-refresh mode by transmitting a MUX control signal 610. Also referring to FIG. 7, in the self-refresh mode, the static frame 702 stored in the static frame buffer 120 is repeatedly outputted to the display panel 106 by the MUX 122 in response to the MUX control signal 610.

In this example, the display data receiver 104 also includes a VBI controller 608 operative to provide VBIs 612 for the display frames to be outputted to the display panel 106. It is known in the art that VBIs may be used for the display frame timing, and thus, the display frames received by the display data receiver 104 may be re-timed by new VBIs 612 provided by the VBI controller 608 of the display data receiver 104. In the normal mode, standard VBIs 706 may be used by the VBI controller 608 for re-timing. In the self-refresh mode, VBIs 704 with a different number of blanking scan lines may be provided by the VBI controller 608 to the static frames 702 for re-timing. The VBIs 704 used in the self-refresh mode may be different from the VBIs 706 used in the normal mode. In other words, the display data receiver 104 may provide its own VBIs 704 for repeatedly outputting the static frame 702 in the self-refresh mode. The VBI controller 608 is further operative to control a transmitter 614 of the display data receiver 104 to transmit the re-timed display frames with new VBIs 612 to the display panel 106 for display.

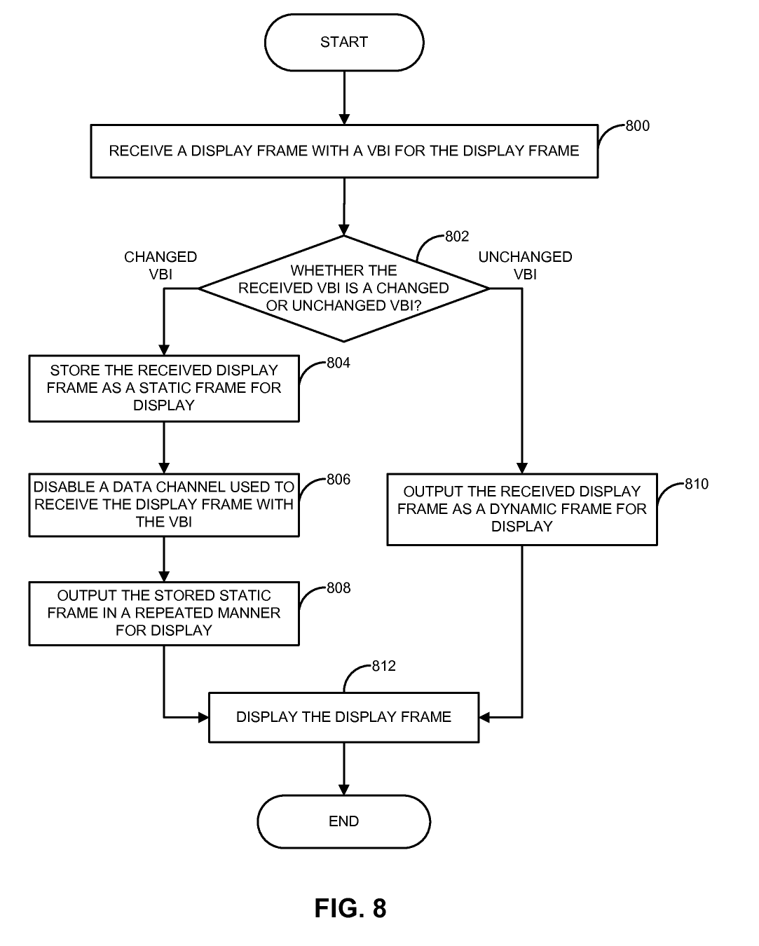

FIG. 8 illustrates an example of a method for providing an indication of a static frame. It will be described with reference to FIGS. 1 and 6. However, any suitable logic or structure may be employed. In operation, at block 800, the interface 116 of the display data receiver 104 receives a display frame with a VBI 412 for the display frame. At block 802, the VBI detector 600 detects whether the receive VBI 412 is a changed VBI or an unchanged VBI. If the VBI detector 600 detects that the received VBI 412 is a changed VBI, then the apparatus 100 is in the self-refresh mode, and the method proceeds to block 804. At block 804, the VBI detector 600 controls the static frame buffer 120 to store the received display frame as a static frame 702. Further to block 806, the VBI detector 600 also disables the interface 112 to disable the data channel 110. At block 808, the VBI detector 600 further controls the MUX 122 to output the stored static frame 702 in a repeated manner for display.

Back to block 802, if the VBI detector 600 detects that the received VBI 412 is an unchanged VBI, then the apparatus 100 is in the normal mode, and the method proceeds to block 810. At block 810, the VBI detector 600 controls the MUX 122 to output the received display frame as a dynamic frame 700, 708 directly from the interface 116 to the display panel 106. As shown in FIG. 7, if the dynamic frame 708 is the first dynamic frame after switching back from the self-refresh mode, because the display data transmitter 102 may transmit a training sequence 312 to the display data receiver 104 to initiate the display data receiver 104, a special VBI 710 may be provided by the VBI controller 608 of the display data receiver 104 to synchronize the output of the dynamic frame 708. The number of blanking scan lines in the special VBI 710 may be adjusted by the VBI controller 608 to accommodate the delay of receiving the dynamic frame 308 caused by the training sequence 312.

Eventually, at block 812, the transmitter 614 of the display data receiver 104 transmits the static frame 702 or the dynamic frame 700, 708 to the display panel 106, and the display panel 106 presents the display frame on its screen.

Also, the logic described herein may be implemented as driver software stored on a computer readable medium such as but not limited to CDROM, RAM, other forms of ROM, hard drives, distributed memory, etc., in combination with processors (e.g., CPU, GPU, APU, GPGPU, etc.). As such, driver software may be stored on computer readable medium. The computer readable medium stores instructions executable by one or more processors (e.g., CPU, GPU, APU, GPGPU, etc.) that causes the one or more processors (e.g., CPU, GPU, APU, GPGPU, etc.) to perform operations described herein.

Among other advantages, the method and apparatus provides a simple way to notify the arrival of a static frame, thereby reducing the overall complexity of implementing the self-refreshing feature in graphic processing and display systems. Compared with known solutions, the method and apparatus does not need to change the current DisplayPort standard to add new secondary packets for each display frame, or to transmit additional unsynchronized control/status signals through the sideband channel in order to notify the arrival of a static frame. In addition, as the vertical blanking intervals usually occur at an accurately known frequency, the timing of the notification may be also synchronized to the display frame timing without extra timing signals and synchronization operations. Accordingly, compared with the conventional techniques, the proposed techniques can reduce the complexity of the hardware design and the communication protocol or interface standard of the graphic processing and display systems with the self-refreshing feature. Moreover, the method and apparatus allows for a faster entry/exit time than known solutions, thereby providing a more seamless transition between the normal and self-refresh modes. Other advantages will be recognized by those of ordinary skill in the art.

The above detailed description of the invention and the examples described therein have been presented for the purposes of illustration and description only and not by limitation. It is therefore contemplated that the present invention cover any and all modifications, variations or equivalents that fall within the spirit and scope of the basic underlying principles disclosed above and claimed herein.

What is claimed is:

1. A method for providing an indication of a static frame comprising:
determining that a display frame is a static frame;
in response to a display frame being a static frame, changing a number of blanking scan lines in a vertical blanking interval for the static frame to provide a changed vertical blanking interval for the static frame; and
transmitting the static frame with the changed vertical blanking interval.

2. The method of claim 1, wherein the changed vertical blanking interval is immediately before the static frame.

3. The method of claim 1, wherein changing the number of blanking scan lines comprising changing the number of blanking scan lines in the changed vertical blanking interval to be larger than in an unchanged vertical blanking interval for a dynamic frame.

4. The method of claim 1 further comprising, in response to a display frame being a static frame, disabling a data channel used to transmit the static frame with the changed vertical blanking interval after transmitting the static frame with the changed vertical blanking interval.

5. The method of claim 1 further comprising:
receiving the static frame with the changed vertical blanking interval;
detecting the changed vertical blanking interval; and
in response to the detection, storing the received static frame for display.

6. The method of claim 5 further comprising outputting the stored static frame in a repeated manner for display.

7. The method of claim 6, wherein the changed vertical blanking interval indicates that the stored static frame is to be displayed at a dynamic refresh rate.

8. The method of claim 1 further comprising:
determining that a display frame is a dynamic frame;
in response to a display frame being a dynamic frame, enabling the data channel if the data channel has been disabled; and
transmitting the dynamic frame with an unchanged vertical blanking interval for the dynamic frame.

9. An apparatus for providing an indication of a static frame comprising a display data transmitter comprising:
an interface; and
logic operatively coupled to the interface, operative to:
determine that a display frame is a static frame;
in response to a display frame being a static frame, change a number of blanking scan lines in a vertical blanking interval for the static frame to provide a changed vertical blanking interval for the static frame; and
control the interface to transmit the static frame with the changed vertical blanking interval.

10. The apparatus of claim 9, wherein the changed vertical blanking interval is immediately before the static frame.

11. The apparatus of claim 9, wherein the logic is operative to change the number of blanking scan lines in the changed vertical blanking interval to be larger than in an unchanged vertical blanking interval for a dynamic frame.

12. The apparatus of claim 9, wherein the logic is further operative to, in response to a display frame being a static frame, disable the interface after transmitting the static frame with the changed vertical blanking interval.

13. The apparatus of claim 9 comprising a display data receiver operatively coupled to the display data transmitter, the display data receiver comprising:
an interface operative to receive the static frame with the changed vertical blanking interval from the display data transmitter;
a static frame buffer; and
logic operatively coupled to the interface and the static frame buffer, operative to:
detect the changed vertical blanking interval; and
in response to the detection, control the static frame buffer to store the received static frame for display.

14. The apparatus of claim 13 further comprising a display panel operatively coupled to the display data receiver,
wherein the display data receiver further comprises a multiplexer operative to switch between outputting a static frame and outputting a dynamic frame to the display panel for display; and
wherein the logic of the display data receiver is further operative to, in response to the detection, control the multiplexer to output the stored static frame from the static frame buffer in a repeated manner to the display panel for display.

15. The apparatus of claim 9, wherein the logic is further operative to:
determine that a display frame is a dynamic frame;
in response to a display frame being a dynamic frame, enable the data channel if the data channel has been disabled; and
control the interface of the display data transmitter to transmit the dynamic frame with an unchanged vertical blanking interval for the dynamic frame.

16. A computer readable storage medium comprising executable instructions that when executed by one or more processors causes the one or more processors to:
determine that a display frame is a static frame;
in response to a display frame being a static frame, change a number of blanking scan lines in a vertical blanking interval for the static frame to provide a changed vertical blanking interval for the static frame; and
transmit the static frame with the changed vertical blanking interval.

17. A method for providing an indication of a static frame comprising:
receiving a display frame with a vertical blanking interval for the display frame;
determining whether the received vertical blanking interval is an unchanged vertical blanking interval for a dynamic frame or a changed vertical blanking interval for a static frame based on a number of blanking scan lines in the received vertical blanking interval; and
if the received vertical blanking interval is determined to be the changed vertical blanking interval, storing the received display frame as the static frame for display.

18. The method of claim 17, wherein the vertical blanking interval for the display frame is immediately before the display frame.

19. The method of claim 17, wherein the number of blanking scan lines in the changed vertical blanking interval is larger than in the unchanged vertical blanking interval.

20. The method of claim 17 further comprising:
if the vertical blanking interval is determined to be the changed vertical blanking interval, disabling a data channel used to receive the display frame with the vertical blanking interval; and
outputting the stored static frame in a repeated manner for display.

21. The method of claim 20 further comprising, if the vertical blanking interval is determined to be the unchanged vertical blanking interval, outputting the received display frame as the dynamic frame for display.

22. An apparatus for providing an indication of a static frame comprising:
an interface operative to receive a display frame with a vertical blanking interval for the display frame;
a static frame buffer; and
logic operatively coupled to the interface and the static frame buffer, operative to:
determine whether the received vertical blanking interval is an unchanged vertical blanking interval for a dynamic frame or a changed vertical blanking interval for a static frame based on a number of blanking scan lines in the received vertical blanking interval; and
if the received vertical blanking interval is determined to be the changed vertical blanking interval, control the static frame buffer to store the received display frame as the static frame for display.

23. The apparatus of claim 22, wherein the vertical blanking interval for the display frame is immediately before the display frame.

24. The apparatus of claim 22, wherein the number of blanking scan lines in the changed vertical blanking interval is larger than in the unchanged vertical blanking interval.

25. A computer readable storage medium comprising executable instructions that when executed by one or more processors causes the one or more processors to:
receive a display frame with a vertical blanking interval for the display frame;
determine whether the received vertical blanking interval is an unchanged vertical blanking interval for a dynamic frame or a changed vertical blanking interval for a static frame based on a number of blanking scan lines in the received vertical blanking interval; and
if the received vertical blanking interval is determined to be the changed vertical blanking interval, store the received display frame as the static frame for display.
